(19) United States
(12) Patent Application Publication
(10) Pub. No.: US 2025/0123943 A1
(43) Pub. Date: Apr. 17, 2025

(54) METHOD AND APPARATUS FOR OPTIMIZING PREFETCH PERFORMANCE OF STORAGE DEVICE

(71) Applicant: Samsung Electronics Co., Ltd., Suwon-si (KR)

(72) Inventors: Changyong Oh, Suwon-si (KR); Byeonghui Kim, Suwon-si (KR); Seongho Roh, Suwon-si (KR); Hyeongyu Min, Suwon-si (KR); Hyunkyo Oh, Suwon-si (KR); Dongchan Lee, Suwon-si (KR); Hankyoo Lee, Suwon-si (KR); Kibeen Jung, Suwon-si (KR)

(21) Appl. No.: 18/909,171

(22) Filed: Oct. 8, 2024

(30) Foreign Application Priority Data
Oct. 11, 2023 (KR) 10-2023-0135396
Jan. 23, 2024 (KR) 10-2024-0010405

(51) Int. Cl. G06F 11/34

(52) U.S. Cl. CPC G06F 11/3485; G06F 11/3409; G06F 11/3452

(57) ABSTRACT

Provided are a method and apparatus for optimizing prefetch performance of a storage device. The method of optimizing prefetch performance of a storage device includes receiving prefetch data from the storage device configured to process a workload based on a parameter, generating prefetch performance data for a plurality of combinations of block size and queue depth, based on the prefetch data, generating index data for evaluating the prefetch performance data, based on the prefetch performance data, updating the parameter to generate an updated parameter based on the index data, and transferring, to the storage device, the updated parameter, wherein the generating of the index data includes generating the index data by taking into account an inversion interval in which prefetch performance decreases with an increase in the block size or the queue depth.

### CROSS-REFERENCE TO RELATED APPLICATIONS

This application is based on and claims priority under 35 U.S.C. § 119 to Korean Patent Application No. 10-2023-0135396, filed on Oct. 11, 2023, and Korean Patent Application No. 10-2024-0010405, filed on Jan. 23, 2024, in the Korean Intellectual Property Office, the disclosures of which are incorporated by reference herein in their entireties.

### BACKGROUND

Embodiments of the inventive concept relates to the optimization of prefetch performance, and more particularly, to a method and apparatus for optimizing prefetch performance of a storage device.

Storage systems include hosts and storage devices, and storage devices may include, for example, nonvolatile memory, such as flash memory, and storage controllers for controlling nonvolatile memory. Storage devices may provide data stored in nonvolatile memory to hosts according to read requests of hosts. When receiving read requests for consecutive addresses from hosts, storage devices may perform sequential read operations on nonvolatile memory. Here, storage controllers may prefetch data from nonvolatile memory, thereby improving read performance.

### SUMMARY

Embodiments of the inventive concept provides a method and apparatus for optimizing prefetch performance of a storage device to improve data read performance.

According to an aspect of the inventive concept, there is provided a method of optimizing prefetch performance of a storage device, the method including receiving prefetch data from the storage device configured to process a workload based on a parameter, generating prefetch performance data for a plurality of combinations of block size and queue depth, based on the prefetch data, generating index data for evaluating the prefetch performance data, based on the prefetch performance data, updating the parameter to generate an updated parameter based on the index data, and transferring, to the storage device, the updated parameter, wherein the generating of the index data includes generating the index data by taking into account an inversion interval in which prefetch performance decreases along with an increase in the block size or the queue depth.

According to another aspect of the inventive concept, there is provided an apparatus for optimizing prefetch performance of a storage device, the apparatus including a prefetch performance analyzer configured to receive prefetch data from the storage device, which is configured to process a workload based on a parameter, and to generate prefetch performance data for a plurality of combinations of block size and queue depth, based on the prefetch data, a performance index calculator configured to generate index data for evaluating the prefetch performance data, based on the prefetch performance data, and a parameter optimizer configured to generate an updated parameter by searching for a parameter that optimizes the index data and to transfer the updated parameter to the storage device, wherein the performance index calculator is configured to generate the index data by taking into account an inversion interval in which prefetch performance decreases along with an increase in the block size or the queue depth.

According to another aspect of the inventive concept, there is provided a storage controller configured to optimize prefetch performance of a storage device, which includes nonvolatile memory and the storage controller, the storage controller including a prefetch performance analyzer configured to receive prefetch data from the nonvolatile memory, which is configured to process a workload based on a parameter, and to generate prefetch performance data for a plurality of combinations of block size and queue depth, based on the prefetch data, a performance index calculator configured to generate index data for evaluating the prefetch performance data, based on the prefetch performance data, and a parameter optimizer configured to generate an updated parameter by searching for a parameter that optimizes the index data and to transfer the updated parameter to the storage device, wherein the performance index calculator is configured to generate the index data by taking into account an inversion interval in which prefetch performance decreases along with an increase in the block size or the queue depth.

### BRIEF DESCRIPTION OF THE DRAWINGS

Embodiments will be more clearly understood from the following detailed description taken in conjunction with the accompanying drawings in which:

FIG. 1 is a block diagram illustrating an optimization device and a storage device, according to an embodiment;

FIG. 2 is a block diagram illustrating a storage device including an optimization device, according to an embodiment;

FIG. 3 is a block diagram illustrating a host-storage system including optimization device components embodied in a storage controller according to an embodiment;

FIG. 4 is a block diagram illustrating a host-storage system including optimization device components embodied a host controller according to an embodiment;

FIG. 5 is a block diagram illustrating an optimization device according to an embodiment in more detail;

FIG. 6 is a table illustrating improvement ratios for different combinations of queue depths (QDs) and block sizes (BSs), according to an embodiment;

FIG. 7 provides graphs illustrating prefetch performance improvements according to an embodiment;

FIG. 8 is a table illustrating prefetch performance data for different combinations of QDs and BSs, according to an embodiment;

FIG. 9 is a graph illustrating a prefetch inversion phenomenon according to an embodiment;

FIGS. 10A to 10C are graphs each illustrating a penalty function according to an embodiment;

FIG. 11 is a flowchart illustrating an optimization method according to an embodiment;

FIG. 12 is a flowchart illustrating an optimization method including operations for generating index data according to an embodiment in more detail;

FIG. 13 is a block diagram illustrating a system to which an optimization device according to an embodiment is applied; and

FIG. 14 is a block diagram illustrating a host-storage system according to an embodiment.

### DETAILED DESCRIPTION OF THE EMBODIMENTS

Hereinafter, embodiments of the inventive concept will be described in detail with reference to the accompanying drawings. Like reference numerals in the drawings denote like elements, and thus their description will be omitted. In the following drawings, thicknesses or sizes of each layer are exaggerated for convenience of explanation, and thus the thicknesses or sizes of each layer may slightly differ from the actual shapes and proportions. As used herein, the term “and/or” includes any and all combinations of one or more of the associated listed items. It is noted that aspects described with respect to one embodiment may be incorporated in different embodiments although not specifically described relative thereto. That is, all embodiments and/or features of any embodiments can be combined in any way and/or combination.

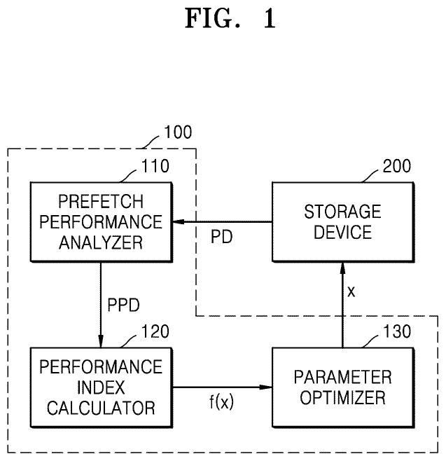

FIG. 1 is a block diagram illustrating an optimization device 100 and a storage device 200, according to an embodiment.

Referring to FIG. 1, the optimization device 100 may include a prefetch performance analyzer 110, a performance index calculator 120, and a parameter optimizer 130. The optimization device 100 may operate to optimize prefetch performance of the storage device 200. A prefetch technique or a prefetcher may refer to a technique of predicting data that is frequently used by or to be used in the future by a processor, reading the data from memory in advance, and storing the data in a cache. The prefetch technique may be one of the methods of reducing a delay time generated between a processor and memory when accessing data and solving a performance gap therebetween.

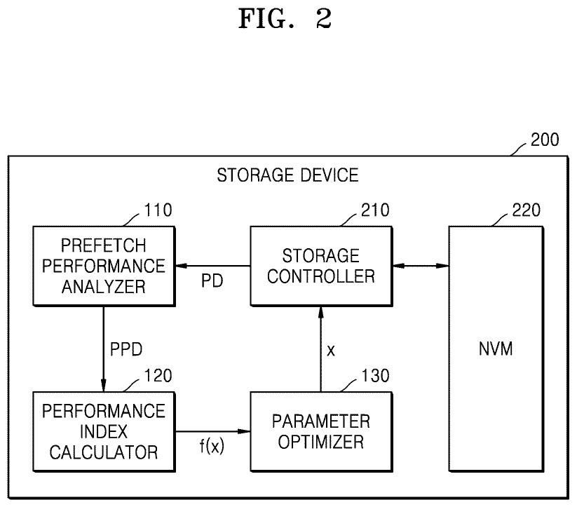

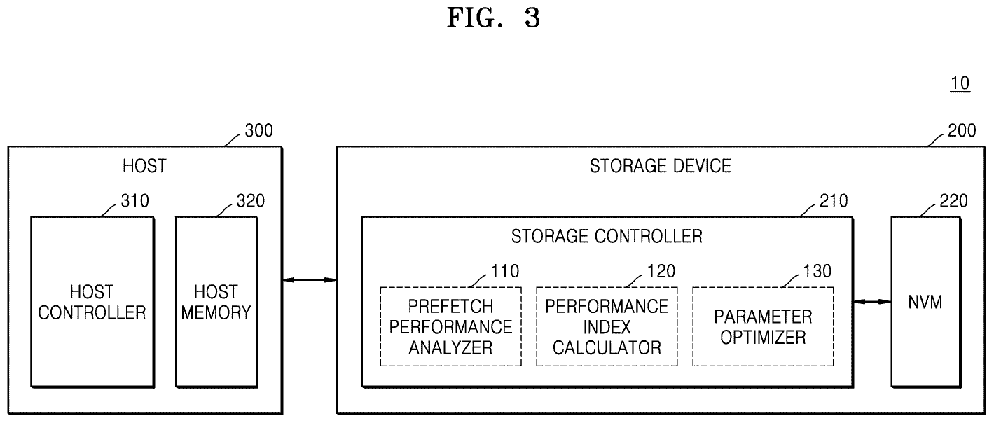

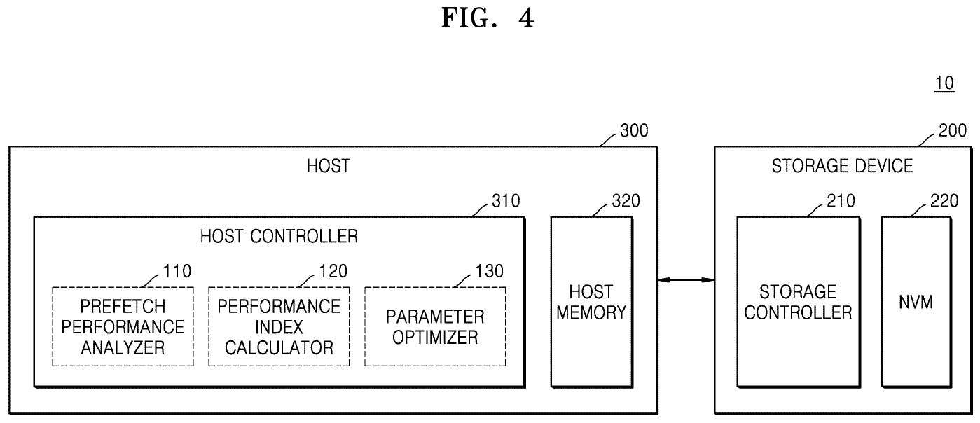

Although FIG. 1 illustrates that the optimization device 100 operates outside the storage device 200 and optimizes the prefetch performance of the storage device 200, this is only an example, and the optimization device 100 may also operate inside the storage device 200. For example, FIG. 2 illustrates an example in which the prefetch performance analyzer 110, the performance index calculator 120, and the parameter optimizer 130 corresponding to components of the optimization device 100 are included in the storage device 200. In addition, FIG. 3 illustrates an example in which the prefetch performance analyzer 110, the performance index calculator 120, and the parameter optimizer 130 corresponding to components of the optimization device 100 are included in a storage controller 210 that is inside the storage device 200. FIG. 4 illustrates an example in which the prefetch performance analyzer 110, the performance index calculator 120, and the parameter optimizer 130 corresponding to the components of the optimization device 100 are included in a host controller 310 that is inside a host 300 of a host-storage system 10. That is, it is noted that the prefetch performance analyzer 110, the performance index calculator 120, and the parameter optimizer 130, which constitute the optimization device 100, are not limited to the case of being outside a storage device, and the examples of FIGS. 2 to 4 are described below in detail. Herein, for convenience of description, an aggregate including the prefetch performance analyzer 110, the performance index calculator 120, and the parameter optimizer 130 is referred to as the optimization device 100.

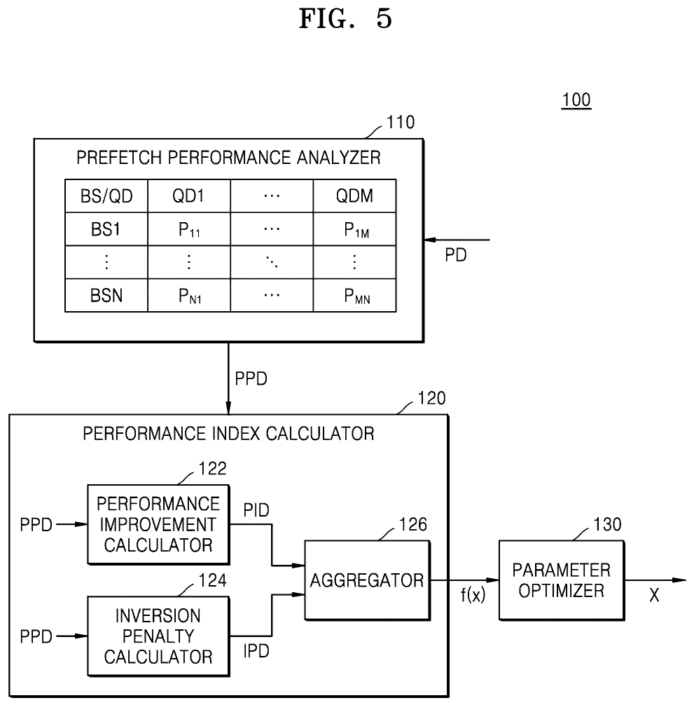

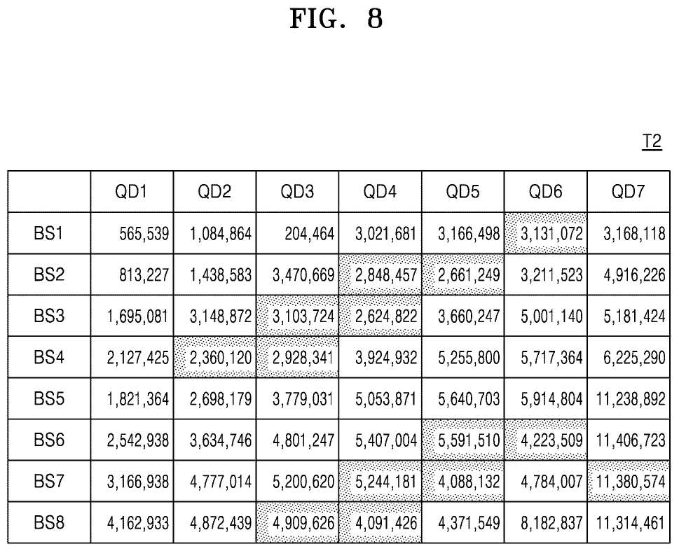

Referring to FIG. 1, the storage device 200 may receive a parameter x from the optimization device 100 and may process a workload by performing a prefetch technique based on the parameter x. A prefetch parameter or the parameter x may collectively refer to factors that may affect the performance of the prefetch technique. The parameter x may be an internal variable and may be a variable capable of affecting the prefetch performance. As described below with reference to FIG. 5 and the like, the prefetch technique may include a plurality of queue depths (QDs) and a plurality of block sizes (BSs). As used herein, the term “prefetch performance” may denote a concept collectively referring to pieces of prefetch performance data, which respectively correspond to the plurality of QDs and the plurality of BSs. The prefetch technique may perform prefetching via different QDs and different BSs depending on the types of data. That is, the prefetch technique may have different performance depending on QDs and BDs, and the parameter x may collectively refer to factors that may affect the performance of the prefetch technique. However, because the prefetch performance herein denotes a concept collectively referring to pieces of prefetch performance data respectively corresponding to the plurality of QDs and the plurality of BSs, the parameter x herein may refer to factors except for the QDs and the BSs. When the parameter x is changed, the prefetch performance data in Table T2 of FIG. 8 described below may be changed.

The storage device 200 may include at least one of a solid-state drive (SSD), embedded memory, and removable external memory. When the storage device 200 includes an SSD, the storage device 200 may conform to non-volatile memory express (NVMe) specifications. When the storage device 200 includes embedded memory or external memory, the storage device 200 may conform to universal flash storage (UFS) or embedded multi-media card (eMMC) specifications.

The storage device 200 may process a workload by performing the prefetch technique, based on the parameter x received from the optimization device 100. When an optimization process is started, the storage device 200 may receive an initial parameter x from the optimization device 100. As described below, the parameter x may be changed during an operation process of the optimization device 100 and may be an object for which an optimum value is to be found.

The prefetch performance analyzer 110 may receive prefetch data PD from the storage device 200. The storage device 200 may generate the prefetch data PD as a result of performing prefetching. The prefetch data PD may include pieces of data obtained by prefetching a workload via different QDs and different BSs. The prefetch performance analyzer 110 may generate prefetch performance data PPD depending on a QD and a BS, based on the prefetch data PD. For example, the prefetch performance analyzer 110 may generate the prefetch performance data PPD including pieces of performance data respectively corresponding to the plurality of QDs and the plurality of BSs, based on the pieces of data obtained by prefetching the workload via the different QDs and the different BSs of the prefetch data PD. The prefetch performance data PPD according to an embodiment may include Table T2 of FIG. 8. The prefetch performance data PPD may indicate the performance of prefetch depending on the QD and the BD and may be changed as the parameter x is changed as described above.

The performance index calculator 120 may generate index data f(x) for evaluating the prefetch performance data PPD, based on the prefetch performance data PPD. The performance of a prefetch may vary depending on different QDs and different BSs. When the capacity of a block increases due to an increase in the BS or the number of blocks loaded in a queue increases due to an increase in the QD, the prefetch performance may increase. That is, throughput, which refers to the amount of data capable of being processed per unit time, may be increased. However, the prefetch performance may decrease even when the BS or the QD increases. An interval in which the prefetch performance decreases even when the BS or the QD increases may be referred to as an inversion interval, and a phenomenon in which such an inversion interval occurs in the prefetch technique may be referred to as an inversion phenomenon. The optimization device 100 may optimize the prefetch performance by taking into account such an inversion phenomenon. The inversion phenomenon causes the amount of data that is processed, that is, the throughput, to decrease despite an increase in the BS or the QD and thus may generate a setback in a host-storage system intended to perform prefetching with a different BS and/or a different QD depending on the type of data. Therefore, in evaluating the prefetch performance data PPD, it may be necessary to give a higher rating to data having undergone a less degree of the inversion phenomenon. In addition, the prefetch performance data PPD may be evaluated by taking into account a performance improvement ratio, which is the degree of improvement in the prefetch performance due to the application of a parameter as compared with the prefetch performance in an existing product. Furthermore, the prefetch performance data PPD may be evaluated by taking into account uniformity data indicating the degree of uniformity in performance improvement ratios in the workload depending on all combinations of QDs and BSs taken into account. That is, the index data f(x) may be generated by taking into account various factors, such as the degree of the occurrence of the inversion phenomenon, the performance improvement ratio of prefetch, and the degree of uniformity in performance improvement ratios. In addition, latency data of prefetch, the maximum inversion value of the inversion phenomenon, or the like may be taken into account. Detailed descriptions of the generation of the index data f(x) are made below with reference to FIG. 5.

The index data f(x) may be used as an indicator for evaluating the prefetch performance data PPD. That is, the index data f(x) may be designed to have a larger value as the index data f(x) approaches the targeted prefetch performance. This is the case of assuming that the index data f(x) is optimized to have a maximum value, and, in other embodiments, the index data f(x) may be designed to have a smaller value as the index data f(x) approaches the targeted prefetch performance.

The parameter optimizer 130 may generate an updated parameter x by searching for the parameter x capable of optimizing the index data f(x). In addition, the parameter optimizer 130 may transfer or communicate the updated parameter x to the storage device 200. The parameter optimizer 130 may search for the parameter x causing an optimum index data f(x) to be obtained. The index data f(x) may be affected by the parameter x and may be a function of the parameter x. However, a relational expression between the index data f(x) and the parameter x may not be given as an accurate expression, and optimization may be performed via information of the index data f(x) corresponding to the parameter x that is input. That is, a process of searching for the parameter x causing an optimum index data f(x) to be obtained, which is an optimization process by the parameter optimizer 130, may be a black-box function optimization process.

In evaluating the prefetch technique, when the parameter x is updated and the updated parameter is applied, a process of deriving new index data f(x) corresponding to the updated parameter may take certain amounts of time and resources. Therefore, there may be a need of an optimization process for searching for the parameter x allowing the optimum index data f(x) to be derived even by a small number of repetitions of the optimization process. An optimization technique of the parameter optimizer 130, according to an embodiment, may include Bayesian optimization.

The optimization device 100 may repeatedly perform a series of processes described above to optimize the prefetch performance. That is, the optimization device 100 may transfer or communicate the generated parameter x to the storage device 200 and may receive, from the storage device 200, the prefetch data PD generated as a result of performing prefetching based on the parameter x. Next, the optimization device 100 may generate the prefetch performance data PPD, may generate the index data f(x), and may generate the updated parameter by searching for a parameter capable of optimizing or that optimizes the index data f(x). These repetitions of the optimization process may be terminated when a termination condition is satisfied. For example, the termination condition may include a condition in which the number of repetitions of the optimization process reaches a threshold number, or a condition in which the index data f(x) reaches a threshold value or more. The optimization device 100 may generate the index data f(x) by taking into account various factors, such as the degree of the occurrence of the inversion phenomenon, the performance improvement ratio of prefetch, and the degree of uniformity in performance improvement ratios, thereby effectively optimizing the prefetch performance even while taking into account the inversion phenomenon.

According to the embodiment described above, the optimization device 100 may optimize the prefetch performance by taking into account performance improvement and performance inversion for various QDs and BSs and may effectively and quickly optimize the prefetch performance by searching for an optimum parameter even with a small number of repetitions of the optimization process.

FIG. 2 is a block diagram illustrating the storage device 200 including an optimization device according to an embodiment.

Specifically, FIG. 2 illustrates an example in which the prefetch performance analyzer 110, the performance index calculator 120, and the parameter optimizer 130 corresponding to components of the optimization device 100 of FIG. 1 are included in the storage device 200. The storage device 200 may include the prefetch performance analyzer 110, the performance index calculator 120, the parameter optimizer 130, the storage controller 210, and nonvolatile memory 220. Although FIG. 2 illustrates that the prefetch performance analyzer 110, the performance index calculator 120, and the parameter optimizer 130, which are components of the optimization device 100, are separate components from the storage controller 210, this is only an example, and the prefetch performance analyzer 110, the performance index calculator 120, and the parameter optimizer 130 may be components operating inside the storage controller 210. For example, FIG. 3 illustrates an example in which the prefetch performance analyzer 110, the performance index calculator 120, and the parameter optimizer 130 corresponding to components of the optimization device 100 are included in the storage controller 210 that is inside the storage device 200. Descriptions of FIG. 2 are made below with reference to FIG. 1 described above, and repeated descriptions given with reference to FIG. 1 are omitted.

When the nonvolatile memory 220 includes flash memory, the flash memory may include a 2-dimensional (2D) NAND memory array or a 3-dimensional (3D, or Vertical) NAND (VNAND) memory array. As another example, the storage device 200 may include other various types of nonvolatile memory. For example, the storage device 200 may include magnetic RAM (MRAM), spin-transfer torque MRAM, conductive bridging RAM (CBRAM), ferroelectric RAM (FeRAM), phase-change RAM (PRAM), resistive RAM, or other various types of memory.

The storage controller 210 is arranged in the storage device 200 and may perform a series of processes or operations of storing data according to a request received from a host by the storage device 200. Referring to FIG. 2, the storage controller 210 may receive a parameter x from the parameter optimizer 130 and may process a workload by performing a prefetch technique based on the parameter x. The storage controller 210 may process a workload by performing the prefetch technique while communicating with the nonvolatile memory 220.

The prefetch performance analyzer 110 may receive the prefetch data PD from the storage controller 210. The storage controller 210 may generate the prefetch data PD as a result of performing prefetching. The prefetch data PD may include pieces of data obtained by prefetching the workload via different QDs and different BSs. The prefetch performance analyzer 110 may generate the prefetch performance data PPD depending on a QD and a BD, based on the prefetch data PD.

The performance index calculator 120 may generate the index data f(x) for evaluating the prefetch performance data PPD, based on the prefetch performance data PPD. The index data f(x) may be generated by taking into account various factors, such as the degree of the occurrence of the inversion phenomenon, the performance improvement ratio of prefetch, and the degree of uniformity in performance improvement ratios. In addition, latency data of prefetch, the maximum inversion value of the inversion phenomenon, or the like may be taken into account. The index data f(x) may be used as an indicator for evaluating the prefetch performance data PPD. That is, the index data f(x) may be designed to have a larger value as the index data f(x) approaches the targeted prefetch performance. It will be understood that this is merely an example and that the index data f(x) may be designed to have a smaller value as the index data f(x) approaches the targeted prefetch performance.

The parameter optimizer 130 may generate an updated parameter by searching for the parameter x capable of optimizing the index data f(x). In addition, the parameter optimizer 130 may transfer or communicate the updated parameter to the storage controller 210. The parameter optimizer 130 may search for the parameter x allowing the optimum index data f(x) to be obtained.

FIG. 3 is a block diagram illustrating a host-storage system 10 including optimization device components embodied in a storage controller according to an embodiment.

Specifically, FIG. 3 illustrates an example in which the prefetch performance analyzer 110, the performance index calculator 120, and the parameter optimizer 130 corresponding to components of the optimization device 100 are included in the storage controller 210. Although FIG. 3 illustrates that the prefetch performance analyzer 110, the performance index calculator 120, and the parameter optimizer 130, which are components of the optimization device 100, are included in the storage controller 210, this is only an example, and the prefetch performance analyzer 110, the performance index calculator 120, and the parameter optimizer 130 may operate as separate components from the storage controller 210, as shown in FIG. 2. In addition, as shown in FIG. 4, the prefetch performance analyzer 110, the performance index calculator 120, and the parameter optimizer 130 may be components that are included in a host controller 310. Descriptions of FIG. 3 are made below with reference to FIGS. 1 and 2 described above, and repeated descriptions given above are omitted.

Referring to FIG. 3, the host-storage system 10 may include a host 300 and the storage device 200. The host 300 may include the host controller 310 and host memory 320. The host memory 320 may function as buffer memory for temporarily storing data to be transmitted to the storage device 200 or data transmitted from the storage device 200. According to an embodiment, the host controller 310 and the host memory 320 may be respectively implemented by separate semiconductor chips. In other embodiments, the host controller 310 and the host memory 320 may be integrated into the same semiconductor chip. For example, the host controller 310 may include one of a large number of modules arranged in an application processor, and the application processor may be implemented by a system-on-chip (SoC). In addition, the host memory 320 may include embedded memory arranged in the application processor or may include nonvolatile memory or a nonvolatile memory module arranged outside the application processor.

The host controller 310 may control all operations of the host 300, more specifically, operations of other components constituting the host 300. In an embodiment, the host controller 310 may be implemented by a general-purpose processor, a dedicated processor, an application processor, or the like. In addition, the host controller 310 may be implemented by, but is not limited to, a computational processor (for example, a central processing unit (CPU), a graphics processing unit (GPU), an application processor (AP), or the like) including a dedicated logic circuit (for example, a field programmable gate array (FPGA), an application-specific integrated circuit (ASIC), or the like).

The host controller 310 may execute various software loaded in the host memory 320. For example, the host controller 310 may execute an operating system (OS) and application programs.

The host controller 310 may generate a command CMD according to a request from a user and may determine whether to transmit the command CMD to the storage device 200. In addition, the host controller 310 may receive a response RESP. In some embodiments, the host controller 310 may write the command CMD and/or the response RESP to or remove the command CMD and/or the response RESP from a queue that is a processing waiting line.

The host controller 310 may include one or more cores and may further include other intellectual property (IP) for controlling memory and/or the storage device 200. According to an embodiment, each of the cores may execute a queue, which is a processing waiting line of the command CMD and the response RESP processed by the host 300. According to an embodiment, the host controller 310 may further include an accelerator, which is a dedicated circuit for high-speed data operations, such as artificial intelligence (AI) data operations, and the accelerator may include a GPU, a neural processing unit (NPU), and/or a data processing unit (DPU) and may be implemented by a separate chip that is physically independent of other components of the host controller 310.

The host controller 310 may include a host controller interface (HCI), and the HCI may manage an operation of storing data (for example, write data) of the host memory 320 in the nonvolatile memory 220 or storing data (for example, read data) of the nonvolatile memory 220 in the host memory 320. In addition, the storage controller 210 may include a device controller interface (not shown) for interfacing with the host controller 310.

The storage device 200 may include the storage controller 210 and the nonvolatile memory 220. Referring to FIG. 3, the storage controller 210 may receive a parameter x from the parameter optimizer 130 therein and may process a workload by performing a prefetch technique based on the parameter x. The storage controller 210 may process the workload by performing the prefetch technique while communicating with the nonvolatile memory 220.

The storage controller 210 may transfer or communicate the prefetch data PD to the prefetch performance analyzer 110 therein. The prefetch performance analyzer 110 may receive the prefetch data PD. The storage controller 210 may generate the prefetch data PD as a result of performing prefetching. The prefetch performance analyzer 110 may generate the prefetch performance data PPD for a plurality of combinations of QD and BS, based on the prefetch data PD.

The performance index calculator 120 may generate the index data f(x) for evaluating the prefetch performance data PPD, based on the prefetch performance data PPD. The index data f(x) may be generated by taking into account various factors, such as the degree of the occurrence of the inversion phenomenon, the performance improvement ratio of prefetch, and the degree of uniformity in performance improvement ratios. In addition, latency data of prefetch, the maximum inversion value of the inversion phenomenon, or the like may be taken into account. The index data f(x) may be used as an indicator for evaluating the prefetch performance data PPD.

The parameter optimizer 130 may generate an updated parameter by searching for the parameter x capable of optimizing or that optimizes the index data f(x). In addition, the parameter optimizer 130 may transfer or communicate the updated parameter to the storage controller 210. The parameter optimizer 130 may search for the parameter x allowing the optimum index data f(x) to be obtained.

FIG. 4 is a block diagram illustrating a host-storage system 10 including optimization device components embodied a host controller according to an embodiment.

Specifically, FIG. 4 illustrates an example in which the prefetch performance analyzer 110, the performance index calculator 120, and the parameter optimizer 130 corresponding to components of the optimization device 100 of FIG. 1 are included in the host controller 310. Although FIG. 4 illustrates that the prefetch performance analyzer 110, the performance index calculator 120, and the parameter optimizer 130, which are components of the optimization device 100, are included in the host controller 310, this is only an example, and the prefetch performance analyzer 110, the performance index calculator 120, and the parameter optimizer 130 may be included in the storage controller 210, as shown in FIG. 3. Descriptions of FIG. 4 are made below with reference to FIGS. 1 to 3 described above, and repeated descriptions given above are omitted.

Referring to FIG. 4, the host-storage system 10 may include the host 300 and the storage device 200. The storage device 200 may include the storage controller 210 and the nonvolatile memory 220. The host 300 may include the host controller 310 and the host memory 320. The host memory 320 may function as buffer memory for temporarily storing data to be transmitted to the storage device 200 or data transmitted from the storage device 200. The host controller 310 may control all operations of the host 300, more specifically, operations of other components constituting the host 300. The host controller 310 may execute various software loaded in the host memory 320. For example, the host controller 310 may execute an OS and application programs.

Referring to FIG. 4, the storage device 200 may receive a parameter x from the host 300 and may process a workload by performing a prefetch technique based on the parameter x. The storage device 200 may process the workload by performing the prefetch technique.

The prefetch performance analyzer 110 may receive the prefetch data PD from the storage device 200. The storage device 200 may generate the prefetch data PD as a result of performing prefetching. The prefetch performance analyzer 110 may generate the prefetch performance data PPD for a plurality of combinations of QD and BS, based on the prefetch data PD.

The performance index calculator 120 may generate the index data f(x) for evaluating the prefetch performance data PPD, based on the prefetch performance data PPD. The index data f(x) may be generated by taking into account various factors, such as the degree of the occurrence of the inversion phenomenon, the performance improvement ratio of prefetch, and the degree of uniformity in performance improvement ratios. In addition, latency data of prefetch, the maximum inversion value of the inversion phenomenon, or the like may be taken into account. The index data f(x) may be used as an indicator for evaluating the prefetch performance data PPD.

The parameter optimizer 130 may generate an updated parameter by searching for the parameter x capable of optimizing or that optimizes the index data f(x). In addition, the parameter optimizer 130 may transfer the updated parameter to the storage controller 210. The parameter optimizer 130 may search for the parameter x allowing the optimum index data f(x) to be obtained.

According to the embodiment described above, the optimization device 100 may optimize the prefetch performance by taking into account performance improvement and performance inversion for various QDs and BSs and may effectively and quickly optimize the prefetch performance by searching for an optimum parameter even with a small number of repetitions of the optimization process.

FIG. 5 is a block diagram illustrating an optimization device according to an embodiment in more detail.

Referring to FIG. 5, the optimization device 100 may include the prefetch performance analyzer 110, the performance index calculator 120, and the parameter optimizer 130. The performance index calculator 120 may include a performance improvement calculator 122, an inversion penalty calculator 124, and an aggregator 126. Descriptions of FIG. 5 are made below with reference to FIG. 1 and the like described above, and repeated descriptions given above are omitted.

A prefetch technique may include a plurality of QDs (that is, QD1 to QDM) and a plurality of BSs (that is, BS1 to BSN). As used herein, the term “prefetch performance” may denote a concept collectively referring to pieces of prefetch performance data P₁₁ to P_{MN} respectively corresponding to the plurality of QDs (that is, QD1 to QDM, where M is a natural number of 2 or more) and the plurality of BSs (that is, BS1 to BSN, where N is a natural number of 2 or more). The prefetch performance analyzer 110 may receive the prefetch data PD from the storage device 200. The storage device 200 may generate the prefetch data PD as a result of performing prefetching. The prefetch data PD may include pieces of data obtained by prefetching a workload via different QDs and different BSs. The prefetch performance analyzer 110 may generate the prefetch performance data PPD for a plurality of combinations of QD and BS, based on the prefetch data PD. For example, the prefetch performance analyzer 110 may generate the prefetch performance data PPD including pieces of performance data respectively corresponding to the plurality of QDs and the plurality of BSs, based on the pieces of data obtained by prefetching the workload via the different QDs and the different BSs of the prefetch data PD. The prefetch performance data PPD according to an embodiment may include Table T2 of FIG. 8. The prefetch performance data PPD may indicate the performance of prefetch for a plurality of combinations of QD and BD and may be changed as the parameter x is changed as described above.

The performance index calculator 120 may receive the prefetch performance data PPD from the prefetch performance analyzer 110. The received prefetch performance data PPD may be transferred or communicated to the performance improvement calculator 122 and the inversion penalty calculator 124, which are in the performance index calculator 120.

The performance improvement calculator 122 may generate performance improvement data PID for evaluating the degree of improvement in the prefetch performance, based on the prefetch performance data PPD. The performance improvement calculator 122 according to an embodiment may generate the performance improvement data PID by a linear combination of performance improvement ratio data and uniformity data. The performance improvement ratio data may indicate the degree of improvement in the prefetch performance due to the application of a parameter as compared with the prefetch performance in an existing product. The uniformity data may indicate the degree of uniformity in performance improvement ratios for all possible combinations of the BSs and the QDs.

The performance improvement ratio data according to an embodiment may be generated based on a degree by which the prefetch technique corresponding to each QD and/or each BS is improved due to the application of a parameter as compared with the prefetch performance in an existing product. For example, for a parameter x, performance improvement ratio data μ(x) may be represented by Equation 1 shown below.

$$μ ( x ) = \frac{1}{M N} {{\sum }_{m = 1 , … , M}}_{n = 1 , … , N} {f}_{1} ( QDm , QDn \vert x ) \qquad [ Equation l ]$$

When prefetching is performed within the plurality of QDs (that is, QD1 to QDM, where M is a natural number of 2 or more) and the plurality of BSs (that is, BS1 to BSN, where N is a natural number of 2 or more), M and N are respectively the numbers of types of QDs and BSs. For a given parameter x, ƒ₁(QDm,QDn|x) refers to a ratio of the improvement of performance due to the application of the parameter x as compared with the performance before the application of the parameter x, when the QD is QDm (where m is a natural number of M or less) and the BS is BSn (where n is a natural number of N or less). The performance improvement ratio data μ(x) may be represented by an arithmetic mean of ƒ₁(QDm,QDn|x) for all the QDs and the BDs.

In addition, uniformity data σ(x) for the parameter x, according to an embodiment, may be represented by Equation 2 shown below.

$$σ ( x ) = \sqrt{\frac{1}{M N} {{\sum }_{m = 1 , … , M}}_{n = 1 , … , N} {( {f}_{1} ( QDm , QDn \vert x ) - μ ( x ) )}^{2}} \qquad [ Equation 2 ]$$

That is, the uniformity data σ(x) may be data indicating, by a standard deviation, the degree of uniformity in ƒ₁(QDm,QDn|x) at all (QD, BS) pairs for the given parameter x.

The performance improvement calculator 122 may generate the performance improvement data PID through a linear combination of the performance improvement ratio data μ(x) and the uniformity data σ(x). The performance improvement data PID according to an embodiment may be represented by Equation 3 shown below.

$$( PID ) = a \cdot μ ( x ) + b \cdot σ ( x ) \qquad [ Equation 3 ]$$

When a greater performance improvement is achieved, the performance improvement ratio data μ(x) may have a larger value. In addition, when the more uniform performance is achieved throughout all ranges, the uniformity data σ(x) may have a smaller value. Therefore, when the index data is optimized as the maximum value, the coefficient a may have a positive value and the coefficient b may have a negative value. An example of the performance improvement data PID when this is taken into account may be represented by Equation 4 shown below.

$$( PID ) = μ ( x ) - σ ( x ) \qquad [ Equation 4 ]$$

The inversion penalty calculator 124 may generate inversion penalty data IPD for evaluating the degree of reduction in the prefetch performance in an inversion interval, based on the prefetch performance data PPD. The inversion penalty calculator 124 according to an embodiment may generate the inversion penalty data IPD through a linear combination of first penalty data and second penalty data. The first penalty data may indicate the decree of reduction in the prefetch performance along with an increase in the BS. The second penalty data may indicate the decree of reduction in the prefetch performance along with an increase in the QD.

The first penalty data according to an embodiment may be generated based on a degree by which the prefetch technique corresponding to each QD and/or each BS is improved due to the application of a parameter as compared with the prefetch performance in an existing product. For example, for the parameter x, the first penalty data i₁(x) may be represented by Equation 5 shown below.

$${i}_{1} ( x ) = ( \frac{1}{M ( N - 1 )} {{\sum }_{m = 1 , … , M}}_{n = 1 , … , N - 1} P ( {π}^{BS} ( m , n \vert x ) ) ) \qquad [ Equation 5 ]$$

$${π}^{B S} ( m , n \vert x ) = \frac{{f}_{2} ( QDm , QDn \vert x ) - {f}_{2} ( QDm , QD ( n + 1 ) \vert x )}{{f}_{2} ( QDm , QDn \vert x )}$$

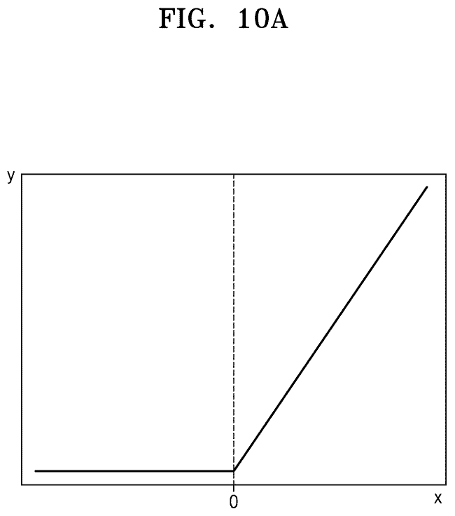

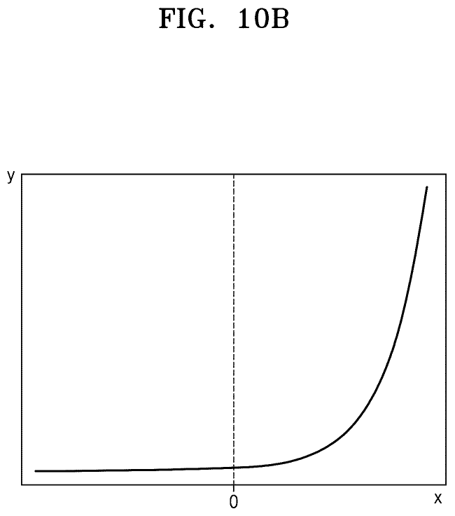

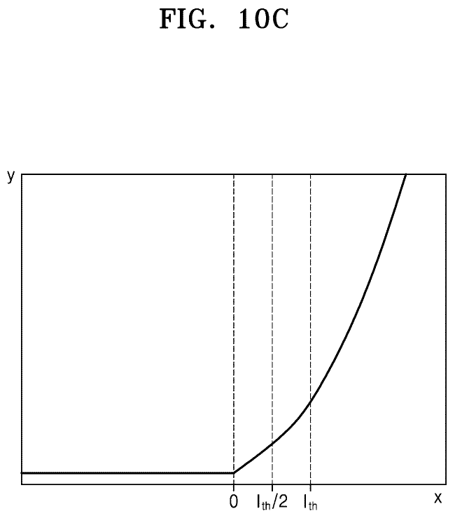

When prefetching is performed within the plurality of QDs (that is, QD1 to QDM, where M is a natural number of 2 or more) and the plurality of BSs (that is, BS1 to BSN, where N is a natural number of 2 or more), M and N are respectively the numbers of types of QDs and BSs. For a given parameter x, ƒ₂(QDm,QDn|x) refers to the performance improved due to the application of the parameter x, when the QD is QDm (where m is a natural number of M or less) and the BS is BSn (where n is a natural number of N or less). Unlike ƒ₁ representing a ratio, ƒ₂ may be a value representing the performance itself. π^{BS}(m,n|x) may represent the degree of the occurrence of the inversion phenomenon at (QDm, BSn) as compared with the prefetch performance at (QDm, BS(n+1)). When the inversion phenomenon has occurred at (QDm, BSn) as compared with the prefetch performance at (QDm, BS(n+1)), π^{BS}(m,n|x) may have a positive value. A function P(⋅), which is a penalty function, may have a positive function value only for a positive value and may have a function value that is 0 or close to 0 for a value of 0 or less. A specific example of the penalty function is described below in detail with reference to FIGS. 10A to 10C. The first penalty data i₁(x) may be represented by an arithmetic mean of P(π^{BS}(m,n|x)) for all the QDs and the BSs.

In addition, the second penalty data i₂(x) according to an embodiment may be represented by Equation 6 shown below.

$${i}_{2} ( x ) = ( \frac{1}{( M - 1 ) N} {{\sum }_{m = 1 , … , M - 1}}_{n = 1 , … , N} P ( {π}^{Q D} ( m , n \vert x ) ) ) \qquad [ Equation 6 ]$$

$${π}^{Q D} ( m , n \vert x ) = \frac{{f}_{2} ( QDm , QDn \vert x ) - {f}_{2} ( QD ( m + 1 ) , QDn \vert x )}{{f}_{2} ( QDm , QDn \vert x )}$$

π^{QD}(m,n|x) may represent the degree of the occurrence of the inversion phenomenon at (QDm, BSn) as compared with the prefetch performance at (QD(m+1), BSn). When the inversion phenomenon has occurred at (QDm, BSn) as compared with the prefetch performance at (QD(m+1), BSn), π^{QD}(m,n|x) may have a positive value. The second penalty data i₂(x) may be represented by an arithmetic mean of P(π^{QD}(m,n|x)) for all the QDs and the BDs.

The inversion penalty calculator 124 may generate the inversion penalty data IPD through a linear combination of the first penalty data i₁(x) and the second penalty data i₂(x). The inversion penalty data IPD according to an embodiment may be represented by Equation 7 shown below.

$$( IPD ) = c \cdot {i}_{1} ( x ) + d \cdot {i}_{2} ( x ) \qquad [ Equation 7 ]$$

When the first penalty data i₁(x) and the second penalty data i₂(x) have the same weight, an example of the inversion penalty data IPD may be represented by Equation 8 shown below.

$$( IPD ) = {i}_{1} ( x ) + {i}_{2} ( x ) \qquad [ Equation 8 ]$$

In addition, when generating the inversion penalty data IPD, the inversion penalty data IPD may be generated by an additional linear combination of maximum π^{QD}(m,n|x) or π^{BS}(m,n|x).

The aggregator 126 may generate the index data f(x) by a linear combination of the performance improvement data PID and the inversion penalty data IPD. For example, for a parameter x, the index data f(x) may be represented by Equation 9 shown below.

$$f ( x ) = α \cdot ( PID ) - β \cdot ( IPD ) \qquad [ Equation 9 ]$$

Because the performance improvement data PID and the inversion penalty data IPD may respectively have different sensitivities depending on the scales thereof and a change in the parameter x, the aggregator 126 may generate the index data f(x) through the weighted sum under the consideration of the scale difference and the importance difference. In addition, because the performance is evaluated as decreasing as the inversion penalty data IPD increases, the coefficient of the inversion penalty data IPD may have a negative value. The aggregator 126 may transfer or communicate the generated index data f(x) to the parameter optimizer 130. In addition, according to an embodiment, the aggregator 126 may generate the index data f(x) by an additional linear combination of latency data of prefetch.

The parameter optimizer 130 may generate an updated parameter by searching for the parameter x capable of optimizing the index data f(x). In addition, the parameter optimizer 130 may transfer the updated parameter to the storage device 200.

According to the embodiment described above, the optimization device 100 may optimize the prefetch performance by taking into account performance improvement and performance inversion for various QDs and BSs and may effectively and quickly optimize the prefetch performance by searching for an optimum parameter even with a small number of repetitions of the optimization process.

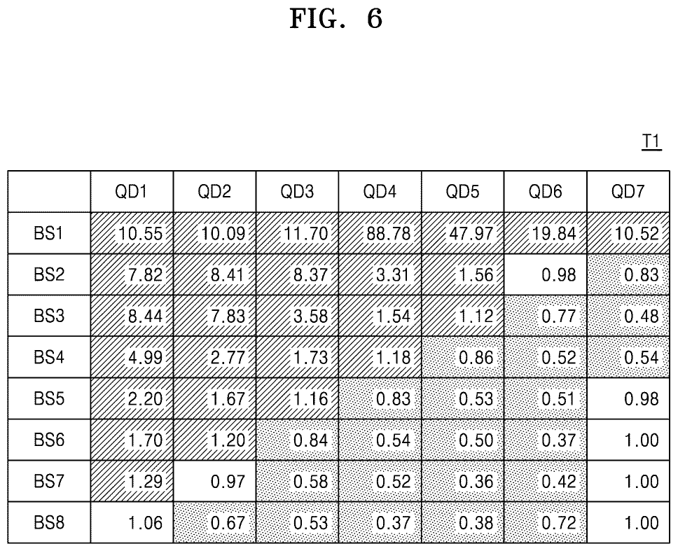

FIG. 6 is Table T1 illustrating improvement ratios of the prefetch performance for a plurality of combinations of QD and BS, according to an embodiment.

Specifically, Table T1 shows the improvement ratio of the prefetch performance, that is, ƒ₁(QDm,QDn|x), for a given parameter x at the plurality of QDs (that is, QD1 to QDM) and the plurality of BSs (that is, BS1 to BSN). Although FIG. 6 illustrates an example in which M is 7 and N is 8, embodiments of the inventive concept are not limited thereto. Descriptions of FIG. 6 are made below with reference to the descriptions given above, and repeated descriptions given above are omitted.

Referring to FIG. 6, Table T1 shows the improvement ratio of the prefetch performance, that is, ƒ₁(QDm,QDn|x), which is used to calculate the performance improvement data PID. ƒ₁(QDm,QDn|x) may represent a degree by which the prefetch performance is improved due to the application of a parameter as compared with the prefetch performance before the application of the parameter, when the QD is QDm (where m is a natural number of M or less) and the BS is BSn (where n is a natural number of N or less). When the numerical values in Table T1 are looked into, it may be confirmed that, although there are areas having values greater than 1 and exhibiting improved prefetch performance as compared with the prefetch performance in an existing product, there are also areas having values less than 1 and exhibiting reduced prefetch performance as compared with the prefetch performance in an existing product.

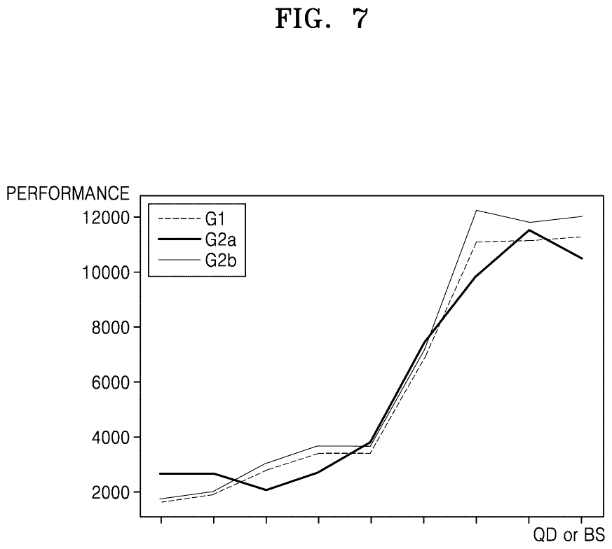

FIG. 7 show graphs illustrating prefetch performance improvements according to an embodiment.

Graph G1 of FIG. 7 illustrates the prefetch performance according to the application of an existing parameter, and Graph G2a and Graph G2b of FIG. 7 respectively illustrate different examples of the prefetch performance according to the application of a parameter updated from the existing parameter. Descriptions of FIG. 7 are made below with reference to the descriptions given above, and repeated descriptions given above are omitted.

Referring to FIG. 7, the y-axis represents values for performance, and the values may be based on the amount of processing, such as throughput. The x-axis may represent the QD or the BS. The graphs of FIG. 7 may each have a pattern in which the prefetch performance increases as each of the QD and the BS increases, and the inversion phenomenon, the prefetch performance improvement ratio, and the like may be confirmed through the graphs of FIG. 7.

As compared with Graph G1, both Graph G2a and Graph G2b may have the same degree of the performance improvement ratio data μ(x). However, Graph G2a and Graph G2b may respectively have different uniformity data σ(x). As compared with Graph G1, it may be confirmed that, although Graph G2a achieves uniform performance improvements in all ranges, Graph G2b achieves relatively non-uniform performance improvements. Although Graph G2a and Graph G2b may have the same value of the performance improvement ratio data μ(x), when referring to Equations described above with reference to FIG. 5, Graph G2a having relatively lower uniformity data σ(x) may have higher index data f(x). Therefore, by taking into account both the performance improvement ratio data μ(x) and σ(x) in taking into account the performance improvement data PID, the effective optimization of the prefetch performance may be achieved.

FIG. 8 is a table illustrating prefetch performance data depending on various combinations of QDs and BSs, according to an embodiment.

Specifically, Table T2 shows the prefetch performance, that is, ƒ₂(QDm,QDn|x), for a given parameter x at the plurality of QDs (that is, QD1 to QDM) and the plurality of BSs (that is, BS1 to BSN). Although FIG. 8 illustrates an example in which M is 7 and N is 8, embodiments of the inventive concept are not limited thereto. Descriptions of FIG. 8 are made below with reference to the descriptions given above, and repeated descriptions given above are omitted.

In theory, the performance of a prefetching operation may linearly increase as the BS or the QD increases. However, actually, during the prefetching operation, read performance may be reduced in a specific range of BSs or QDs.

Referring to FIG. 8, Table T2 shows ƒ₂(QDm,QDn|x) used to calculate the inversion penalty data IPD. In most cases, it may be confirmed that, when the capacity of a block increases due to an increase in the BS or the number of blocks loaded in a queue increases due to an increase in the QD, the prefetch performance increases. However, shaded areas in Table T2 indicate areas in which the prefetch performance decreases despite an increase in the BS or the QD. The prefetch performance data PPD according to an embodiment may include the prefetch performance, ƒ₂(QDm,QDn|x), for a given parameter x at the plurality of QDs (that is, QD1 to QDM) and the plurality of BSs (that is, BS1 to BSN), as shown in Table T2. The prefetch performance data PPD may be used as data for generating the index data f(x). In addition, as the parameter x is updated, the prefetch performance data PPD may also be updated.

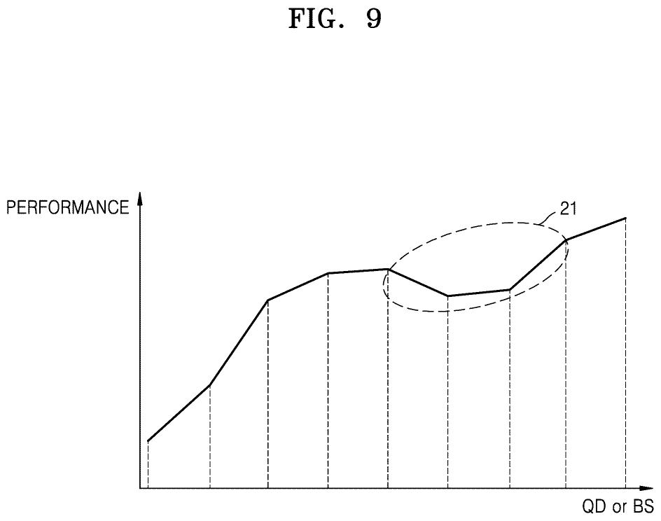

FIG. 9 is a graph illustrating a prefetch inversion phenomenon according to an embodiment.

Referring to FIG. 9, the y-axis represents values for performance, and the values may be based on the amount of processing, such as throughput. The x-axis may represent the QD or the BS. The graph of FIG. 9 may have a pattern in which the prefetch performance increases as each of the QD and the BS increases, and the inversion phenomenon, the prefetch performance improvement ratio, and the like may be confirmed through the graph of FIG. 9.

Referring to an interval 21, it may be confirmed that the prefetch performance decreases despite an increase in the QD or the BS. Because such an inversion phenomenon causes the amount of processing of data, that is, the throughput, to be reduced despite an increase in the QD or the BS, the inversion phenomenon may cause a setback in a host-storage system intended to perform prefetching with a different BS and/or a different QD depending on the type of data.

By generating the inversion penalty data IPD described above and the index data f(x) that is based thereon, the inversion phenomenon, such as the interval 21, may be reduced or minimized.

According to the embodiment described above, the optimization device 100 may optimize the prefetch performance by taking into account performance improvement and performance inversion for various QDs and BSs and may effectively and quickly optimize the prefetch performance by searching for an optimum parameter even with a small number of repetitions of the optimization process.

FIGS. 10A to 10C are graphs each illustrating a penalty function according to an embodiment.

Specifically, FIG. 10A illustrates a rectified linear unit (ReLU) function, FIG. 10B illustrates an exponential function, and FIG. 10C illustrates another penalty function. Descriptions of FIGS. 10A to 10C are made below with reference to the descriptions given above, and repeated descriptions given above are omitted.

A penalty function P(⋅) may have a positive function value only for a positive value and may have a function value that is 0 or close to 0 for a value of 0 or less. In the case of the occurrence of the inversion phenomenon in which π^{BS}(m,n|x) or π^{QD}(m,n|x) has a positive value, the penalty function P(⋅) may be used to give a penalty value corresponding thereto.

Referring to FIG. 10A, the penalty function P(⋅) may be an ReLU function. The ReLU function may be represented by max (0, x) and may output 0 in a negative range and output an input value intactly in a positive range. The ReLU function may be used as a penalty function for giving a linear penalty in the positive range.

Referring to FIG. 10B, the penalty function P(⋅) may be an exponential function. The exponential function may be used as a penalty function for implementing the application of a greater penalty along with an increasing value, in the positive range.

Referring to FIG. 10C, the penalty function P(⋅) may be divided into three ranges in a large aspect. For example, in a range equal to or less than 0, the penalty function may output a value of 0. In a range between 0 and Iₜₕ and in a range equal to or greater than Iₜₕ, the slope patterns of the graph may be different. The penalty function of FIG. 10C may be used to give an additional penalty in a range equal to or greater than Iₜₕ.

According to the embodiment described above, the optimization device 100 may optimize the prefetch performance by taking into account performance improvement and performance inversion for various QDs and BSs and may effectively and quickly optimize the prefetch performance by searching for an optimum parameter even with a small number of repetitions of the optimization process.

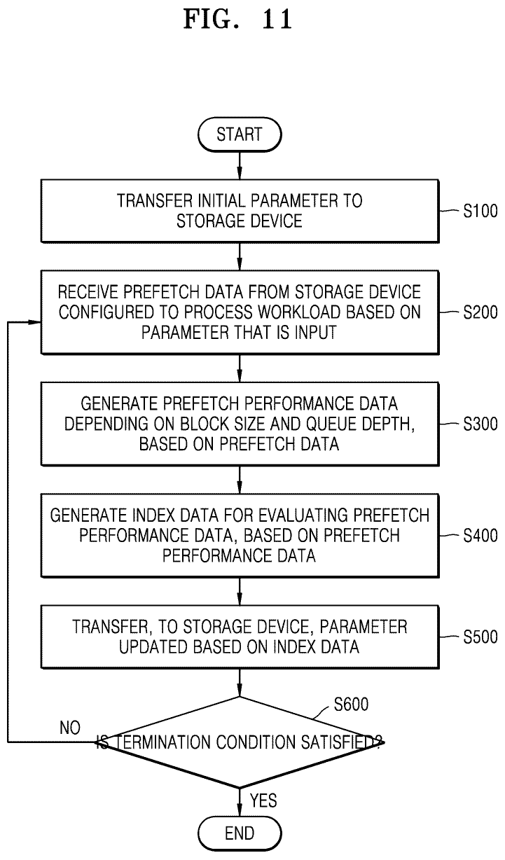

FIG. 11 is a flowchart illustrating an optimization method according to an embodiment.

Referring to FIG. 11, an optimization method of the prefetch performance may include a plurality of operations S100 to S600. Although FIG. 11 illustrates that the optimization device 100 performs the optimization method for convenience of description, this is only an example, and embodiments of the inventive concept are not limited thereto. For example, the host controller 310, the storage controller 210, or the storage device 200 itself may perform the optimization method. Descriptions of FIG. 11 are made below with reference to the descriptions given above, and repeated descriptions given above are omitted.

In operation S100, the optimization device 100 may transfer an initial parameter to the storage device 200. Operation S100 is performed at the start of an optimization process and may be omitted in the middle of repetitions of the optimization process. The initial parameter may be arbitrarily determined, or a predetermined value may be input as the initial parameter. In addition, the initial parameter may be determined by a user input.

In operation S200, the optimization device 100 may receive the prefetch data PD from the storage device 200, which processes a workload based on the parameter x that is input. The storage device 200 may generate the prefetch data PD as a result of performing prefetching. The prefetch data PD may include pieces of data obtained by prefetching the workload via different QDs and different BSs.

In operation S300, the optimization device 100 may generate the prefetch performance data PPD for a plurality of combinations of BS and QD, based on the prefetch data PD. For example, the optimization device 100 may generate the prefetch performance data PPD including pieces of performance data respectively corresponding to the plurality of QDs and the plurality of BSs, based on the pieces of data obtained by prefetching the workload via the different QDs and the different BSs of the prefetch data PD. The prefetch performance data PPD according to an embodiment may include Table T2 of FIG. 8. The prefetch performance data PPD may indicate the performance of prefetch depending on a QD and a BD and may be changed as the parameter x is changed as described above.

In operation S400, the optimization device 100 may generate the index data f(x) for evaluating the prefetch performance data PPD, based on the prefetch performance data PPD. The index data f(x) may be used as an indicator for evaluating the prefetch performance data PPD. The optimization device 100 may generate the performance improvement data PID and the inversion penalty data IPD both for evaluating the degree of improvement in the prefetch performance, based on the prefetch performance data PPD. The optimization device 100 according to an embodiment may generate the performance improvement data PID through a linear combination of performance improvement ratio data and uniformity data. In addition, the optimization device 100 according to an embodiment may generate the inversion penalty data IPD through a linear combination of first penalty data and second penalty data. The optimization device 100 may generate the index data f(x) by a linear combination of the performance improvement data PID and the inversion penalty data IPD. Operation S400 may additionally include an operation of operating, by the optimization device 100 according to an embodiment, the index data f(x) by taking into account the inversion range in which the prefetch performance decreases along the BS or the QD. In addition, operation S400 may additionally include an operation of generating, by the optimization device 100 according to an embodiment, the index data f(x) by a linear combination of the performance improvement data PID, the inversion penalty data IPD, and latency data of prefetch.

The parameter x may be updated to generate an updated parameter based on the index data f(x). In operation S500, the optimization device 100 may transfer or communicate, to the storage device 200, the updated parameter based on the index data f(x). the optimization device 100 may generate the updated parameter by searching for the parameter x capable of optimizing or that optimizes the index data f(x). In addition, the optimization device 100 may transfer or communicate the updated parameter to the storage device 200. The optimization device 100 may search for the parameter x allowing the optimum index data f(x) to be obtained. The index data f(x) may be affected by the parameter x and may be a function of the parameter x.

In addition, in operation S600, the optimization device 100 may determine whether a termination condition is satisfied or not. The optimization device 100 may repeatedly perform the aforementioned series of processes to optimize the prefetch performance. That is, the optimization device 100 may transfer the generated parameter x to the storage device 200 and may receive, from the storage device 200, the prefetch data PD generated as a result of performing prefetching based on the parameter x. Next, the optimization device 100 may generate the prefetch performance data PPD, may generate the index data f(x), and may generate the updated parameter by searching for a parameter capable of optimizing the index data f(x). These repetitions of the optimization process may be terminated when the termination condition is satisfied. For example, the termination condition may include a condition in which the number of repetitions of the optimization process reaches a threshold number, or a condition in which the index data f(x) reaches a threshold value or more. When the termination condition is not satisfied in operation S600, the optimization device 100 may proceed to operation S200. When the termination condition is satisfied in operation S600, the optimization device 100 may terminate the optimization method. The optimization device 100 may generate the index data f(x) by taking into account various factors, such as the degree of the occurrence of the inversion phenomenon, the performance improvement ratio of prefetch, and the degree of uniformity in performance improvement ratios, thereby effectively optimizing the prefetch performance even while taking into account the inversion phenomenon.

According to the embodiment described above, the optimization device 100 may optimize the prefetch performance by taking into account performance improvement and performance inversion for various QDs and BSs and may effectively and quickly optimize the prefetch performance by searching for an optimum parameter even with a small number of repetitions of the optimization process.

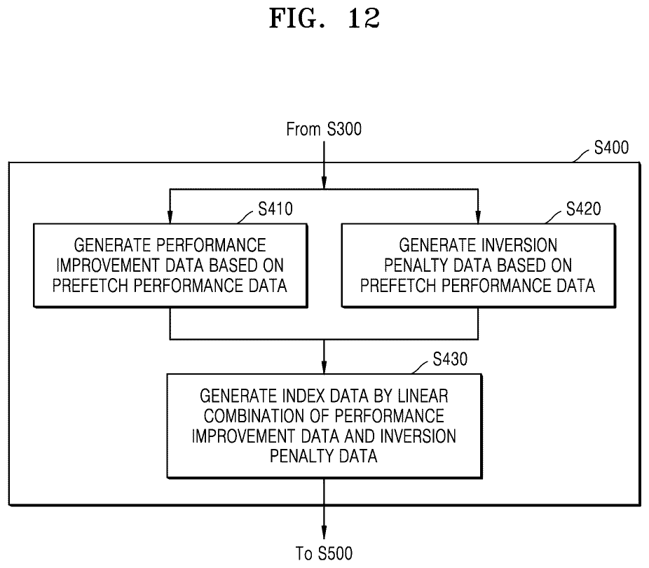

FIG. 12 is a flowchart illustrating an optimization method according to an embodiment in more detail.

Referring to FIG. 12, operation S400 in the optimization method of the prefetch performance may include a plurality of operations S410 to S430. Although FIG. 12 illustrates that the optimization device 100 performs the optimization method for convenience of description, this is only an example, and embodiments of the inventive concept are not limited thereto. For example, the host controller 310, the storage controller 210, or the storage device 200 itself may perform the optimization method. Descriptions of FIG. 12 are made below with reference to the descriptions given above, and repeated descriptions given above are omitted.

In operation S410, the optimization device 100 may generate the performance improvement data PID based on the prefetch performance data PPD. The optimization device 100 according to an embodiment may generate the performance improvement data PID through a linear combination of performance improvement ratio data and uniformity data.

In operation S420, the optimization device 100 may generate the inversion penalty data IPD based on the prefetch performance data PPD. The optimization device 100 according to an embodiment may generate the inversion penalty data IPD through a linear combination of first penalty data and second penalty data.

In operation S430, the optimization device 100 may generate the index data f(x) through a linear combination of the performance improvement data PID and the inversion penalty data IPD. Because the performance improvement data PID and the inversion penalty data IPD may respectively have different sensitivities depending on the scales thereof and a change in the parameter x, the optimization device 100 may generate the index data f(x) through the weighted sum under the consideration of the scale difference and the importance difference.

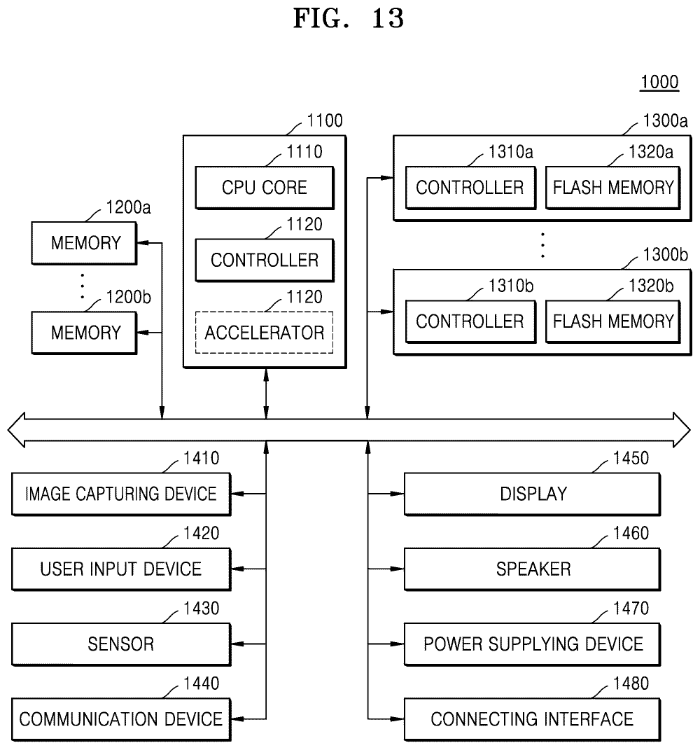

FIG. 13 is a block diagram illustrating a system 1000 to which an optimization device according to an embodiment is applied.

The system 1000 of FIG. 13 may include a mobile system, such as a mobile phone, a smartphone, a tablet personal computer (PC), a wearable device, a healthcare device, or an Internet-of-Things (IoT) device. However, the system 1000 of FIG. 13 is not limited to a mobile system and may include a PC, a laptop computer, a server, a media player, or an automotive device such as a navigation system.

Referring to FIG. 13, the system 1000 may include a main processor 1100, memories 1200a and 1200b, and storage devices 1300a and 1300b and may additionally include one or more of an image capturing device 1410, a user input device 1420, a sensor 1430, a communication device 1440, a display 1450, a speaker 1460, a power supplying device 1470, and a connecting interface 1480.

The main processor 1100 may control all operations of the system 1000, more specifically, operations of other components constituting the system 1000. The main processor 1100 may be implemented by a general-purpose processor, a dedicated processor, an AP, or the like.

The main processor 1100 may include one or more CPU cores 1110 and may further include a controller 1120 for controlling the memories 1200a and 1200b and/or the storage devices 1300a and 1300b. Depending on embodiments, the main processor 1100 may further include an accelerator 1130, which is a dedicated circuit for high-speed data operations such as AI data operations. The accelerator 1130 may include a GPU, an NPU, and/or a DPU and may be implemented by a separate chip that is physically independent of other components of the main processor 1100.

The memories 1200a and 120 may be used as main memory devices of the system 1000 and may each include a volatile memory, such as SRAM and/or DRAM, or nonvolatile memory, such as PRAM and/or RRAM. The memories 1200a and 1200b may be implemented in the same package as that of the main processor 1100.

The storage devices 1300a and 1300b may function as nonvolatile storage devices storing data regardless of whether power is supplied thereto or not. The storage devices 1300a and 1300b may include storage controllers 1310a and 1310b and nonvolatile memories 1320a and 1320b storing data under the control of the storage controllers 1310a and 1310b, respectively. The nonvolatile memories 1320a and 1320b may each include flash memory having a 2D structure or a 3D VNAND structure or other types of nonvolatile memory, such as PRAM and/or RRAM.

The storage devices 1300a and 1300b may be included in the system 1000 while physically separated from the main processor 1100 or may be implemented in the same package as that of the main processor 1100. In addition, each of the storage devices 1300a and 1300b may have the same form as an SSD or a memory card and thus may be removably coupled to other components of the system 1000 via an interface, such as the connecting interface 1480 described below. Each of the storage devices 1300a and 1300b may include, but is not limited to, a device to which standard specifications, such as UFS, eMMC, or nonvolatile memory express (NVMe), are applied.

The image capturing device 1410 may capture still images or moving images and may include a camera, a camcorder, and/or a webcam. The user input device 1420 may receive various types of data from a user of the system 1000 may include a touch pad, a keypad, a keyboard, a mouse, and/or a microphone. The sensor 1430 may sense various types of physical quantities, which may be obtained from outside the system 1000, and may convert the sensed physical quantities into electrical signals. The sensor 1430 may include a temperature sensor, a pressure sensor, an illuminance sensor, a position sensor, an acceleration sensor, a biosensor, and/or a gyroscope sensor. The communication device 1440 may perform transmission and reception of signals with respect to other devices outside of the system 1000 according to various communication protocols. The communication device 1440 may be implemented to include an antenna, a transceiver, and/or a modem.

The display 1450 and the speaker 1460 may function as output devices outputting visual information and auditory information to the user of the system 1000, respectively. The power supplying device 1470 may appropriately convert power supplied from a battery (not shown) embedded in the system 1000 and/or an external power supply and may supply the power to the respective components of the system 1000. The connecting interface 1480 may provide a connection between the system 1000 and an external device that is connected to the system 1000 and may exchange data with the system 1000. The connecting interface 1480 may be implemented by various interface methods, such as Advanced Technology Attachment (ATA), Serial ATA (SATA), external SATA (e-SATA), Small Computer Small Interface (SCSI), Serial Attached SCSI (SAS), Peripheral Component Interconnection (PCI), PCI express (PCIe), NVMe, IEEE 1394, Universal Serial Bus (USB), secure digital (SD) card, multi-media card (MMC), eMMC, UFS, embedded UFS (eUFS), and compact flash (CF) card interfaces.

Each of the storage devices 1300a and 1300b may be an example of the storage device 200 of FIG. 2. In addition, the storage devices 1300a and 1300b and the storage controllers 1310a and 1310b may be examples of the storage device 200 and the storage controller 210 of FIG. 3, respectively.

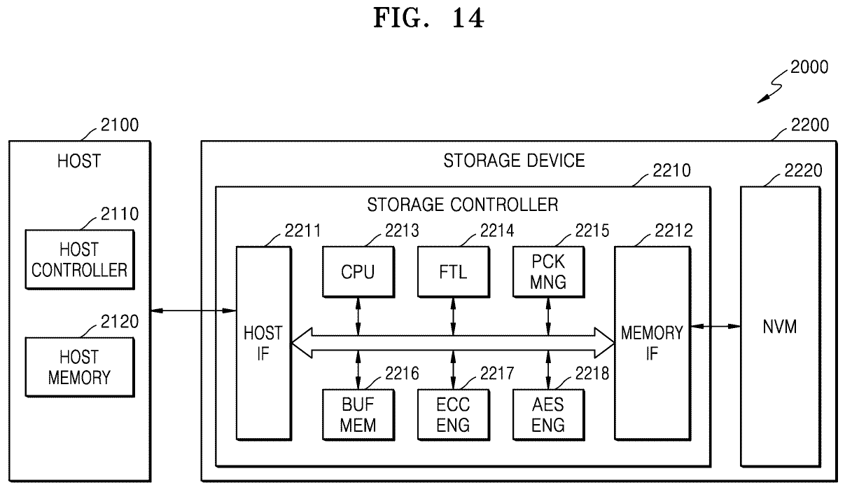

FIG. 14 is a block diagram illustrating a host-storage system 2000 according to an embodiment.

The host-storage system 2000 may include a host 2100 and a storage device 2200. In addition, the storage device 2200 may include a storage controller 2210 and nonvolatile memory 2220. Furthermore, according to an embodiment, the host 2100 may include a host controller 2110 and host memory 2120. The host memory 2120 may function as buffer memory for temporarily storing data to be transmitted to the storage device 2200 or data transmitted from the storage device 2200. For example, the nonvolatile memory 2220 may correspond to the nonvolatile memory 220 of FIGS. 3 and 4, the storage controller 2210 may correspond to the storage controller 210 of FIGS. 3 and 4, and the host 2100 may correspond to the host 300 of FIGS. 3 and 4.

The storage device 2200 may include storage media for storing data according to a request from the host 2100. For example, the storage device 2200 may include at least one of an SSD, embedded memory, and removable external memory. When the storage device 2200 includes an SSD, the storage device 2200 may conform to the NVMe specifications. When the storage device 2200 includes embedded memory or removable external memory, the storage device 2200 may conform to the UFS or eMMC specifications. The host 2100 and the storage device 2200 may respectively generate packets according to standard protocols applied thereto and may respectively transmit the packets.

When the nonvolatile memory 2220 of the storage device 2200 includes flash memory, the flash memory may include a 2D NAND memory array or a 3D (or Vertical) NAND (VNAND) memory array. As another example, the storage device 2200 may include other various types of nonvolatile memory. For example, the storage device 2200 may include MRAM, spin-transfer torque MRAM, CBRAM, FeRAM, PRAM, resistive RAM, or other various types of memory.

According to an embodiment, the host controller 2110 and the host memory 2120 may be respectively implemented by separate semiconductor chips. Alternatively, the host controller 2110 and the host memory 2120 may be integrated into the same semiconductor chip. For example, the host controller 2110 may include one of a large number of modules arranged in an AP, and the AP may be implemented by an SoC. In addition, the host memory 2120 may include embedded memory arranged in the AP or may include nonvolatile memory or a nonvolatile memory module arranged outside the AP.

The host controller 2110 may manage an operation of storing data (for example, data to be written) of a buffer area of the host memory 2120 in the nonvolatile memory 2220 or storing data (for example, read data) of the nonvolatile memory 2220 in the buffer area.

The storage controller 2210 may include a host interface 2211, a memory interface 2212, and a CPU 2213. In addition, the storage controller 2210 may further include a flash translation layer (FTL) 2214, a packet manager 2215, buffer memory 2216, an error correction code (ECC) engine 2217, and an advanced encryption standard (AES) engine 2218. The storage controller 2210 may further include working memory (not shown) in which the FTL 2214 is loaded, and data read and data write operations on the nonvolatile memory 2220 may be controlled by the execution of the FTL 2214 by the CPU 2213.

The host interface 2211 may transmit packets to and receive packets from the host 2100. A packet transmitted from the host 2100 to the host interface 2211 may include a command, data to be written to the nonvolatile memory 2220, or the like, and a packet transmitted from the host interface 2211 to the host 2100 may include a response to the command, data read from the nonvolatile memory 2220, or the like. The memory interface 2212 may transmit data to be written to the nonvolatile memory 2220 to the nonvolatile memory 2220 or may receive data read from the nonvolatile memory 2220. The memory interface 2212 may be implemented to comply with standard specifications, such as Toggle or Open NAND Flash Interface (ONFI).

The FTL 2214 may perform several functions, such as address mapping, wear-leveling, and garbage collection. The address mapping is an operation of converting a logical address, which is received from the host 2100, into a physical address, which is used to actually store data in the nonvolatile memory 2220. The wear-leveling is a technique of preventing the excessive deterioration of a particular block by causing blocks in the nonvolatile memory 2220 to be uniformly used, and as an example, the wear-leveling may be implemented by a firmware technique of balancing erase counts of physical blocks. The garbage collection is a technique of securing available capacity in the nonvolatile memory 2220 in the manner of copying effective data of a block into a new block and then erasing the existing block.

The packet manager 2215 may generate a packet according to a protocol of an interface, which is agreed on with the host 2100, or may parse various information from a packet received from the host 2100. In addition, the buffer memory 2216 may temporarily store data to be written to the nonvolatile memory 2220 or data read from the nonvolatile memory 2220. Although the buffer memory 2216 may be arranged in the storage controller 2210, it does not matter that the buffer memory 2216 is arranged outside the storage controller 2210.

The ECC engine 2217 may perform an error detection or correction operation on read data, which is read from the nonvolatile memory 2220. More specifically, the ECC engine 2217 may generate parity bits for write data, which is to be written to the nonvolatile memory 2220, and the parity bits generated as such, together with the write data, may be stored in the nonvolatile memory 2220. When data is read from the nonvolatile memory 2220, the ECC engine 2217 may correct errors in the read data by using parity bits that are read, together with the read data, from the nonvolatile memory 2220, and may output the read data that is error-corrected.

The AES engine 2218 may perform at least one of an encryption operation or a decryption operation on data that is input to the storage controller 2210, by using a symmetric-key algorithm.

The storage device 2200 may be an example of the storage device 200 of FIG. 2. In addition, the storage device 2200 and the storage controller 2210 may be respectively examples of the storage device 200 and the storage controller 210 of FIG. 3.

While the inventive concept has been particularly shown and described with reference to embodiments thereof, it will be understood that various changes in form and details may be made therein without departing from the spirit and scope of the following claims.

What is claimed is:

1. A method off optimizing prefetch performance of a storage device, the method comprising:
receiving prefetch data from the storage device configured to process a workload based on a parameter;
generating prefetch performance data for a plurality of combinations of block size and queue depth, based on the prefetch data;
generating index data for evaluating the prefetch performance data, based on the prefetch performance data;
updating the parameter to generate an updated parameter based on the index data; and
transferring, to the storage device, the updated parameter,
wherein the generating of the index data comprises generating the index data by taking into account an inversion interval in which prefetch performance decreases along with an increase in the block size or the queue depth.

2. The method of claim 1, wherein the generating of the index data comprises:
generating performance improvement data for evaluating a degree of improvement in the prefetch performance, based on the prefetch performance data;
generating inversion penalty data for evaluating a degree of reduction in the prefetch performance in the inversion interval, based on the prefetch performance data; and
generating the index data by a linear combination of the performance improvement data and the inversion penalty data.

3. The method of claim 2, wherein the performance improvement data comprises a linear combination of performance improvement ratio data, which indicates a degree of improvement in the prefetch performance due to application of the parameter as compared with the prefetch performance before the application of the parameter, and uniformity data, which indicates a degree of uniformity in the performance improvement ratio data along with an increase in the block size or the queue depth.

4. The method of claim 2, wherein the inversion penalty data comprises a linear combination of first penalty data, which indicates a degree of reduction in the prefetch performance along with an increase in the block size, and second penalty data, which indicates a degree of reduction in the prefetch performance along with an increase in the queue depth.

5. The method of claim 2, wherein the generating of the index data comprises generating the index data by a linear combination of the performance improvement data, the inversion penalty data, and latency data of prefetch.

6. The method of claim 1, wherein a sequence of the receiving of the prefetch data, the generating of the prefetch performance data, the generating of the index data, the updating of the parameter to generate an updated parameter, and the transferring of the updated parameter to the storage device is repeatedly performed until a termination condition is satisfied.

7. The method of claim 6, wherein the termination condition comprises a condition in which the number of repetitions of the sequence reaches a threshold number, or a condition in which the index data satisfies a threshold value.

8. The method of claim 1, wherein updating the parameter comprises searching for a parameter that optimizes the index data.

9. The method of claim 8, wherein the optimizing of the index data is performed based on Bayesian optimization.

10. An apparatus for optimizing prefetch performance of a storage device, the apparatus comprising:
a prefetch performance analyzer configured to receive prefetch data from the storage device, which is configured to process a workload based on a parameter, and to generate prefetch performance data for a plurality of combinations of block size and queue depth, based on the prefetch data;
a performance index calculator configured to generate index data for evaluating the prefetch performance data, based on the prefetch performance data; and
a parameter optimizer configured to generate an updated parameter by searching for a parameter that optimizes the index data and to transfer the updated parameter to the storage device,
wherein the performance index calculator is configured to generate the index data by taking into account an inversion interval in which prefetch performance decreases along with an increase in the block size or the queue depth.

11. The apparatus of claim 10, wherein the performance index calculator comprises:
a performance improvement calculator configured to generate performance improvement data for evaluating a degree of improvement in the prefetch performance, based on the prefetch performance data;
an inversion penalty calculator configured to generate inversion penalty data for evaluating a degree of reduction in the prefetch performance in the inversion interval, based on the prefetch performance data; and
an aggregator configured to generate the index data by a linear combination of the performance improvement data and the inversion penalty data.

12. The apparatus of claim 11, wherein the performance improvement calculator is configured to generate the performance improvement data by a linear combination of performance improvement ratio data, which indicates a degree of improvement in the prefetch performance due to application of the parameter as compared with the prefetch performance before the application of the parameter, and uniformity data, which indicates a degree of uniformity in the performance improvement ratio data along with an increase in the block size or the queue depth.

13. The apparatus of claim 11, wherein the inversion penalty calculator is configured to generate the inversion penalty data by a linear combination of first penalty data, which indicates a degree of reduction in the prefetch performance along with an increase in the block size, and second penalty data, which indicates a degree of reduction in the prefetch performance along with an increase in the queue depth.

14. The apparatus of claim 11, wherein the aggregator is configured to generate the index data by a linear combination of the performance improvement data, the inversion penalty data, and latency data of prefetch.

15. The apparatus of claim 10, wherein the parameter optimizer is configured to generate the updated parameter based on Bayesian optimization.

16. A storage controller configured to optimize prefetch performance of a storage device, which comprises nonvolatile memory and the storage controller, the storage controller comprising:
a prefetch performance analyzer configured to receive prefetch data from the nonvolatile memory, which is configured to process a workload based on a parameter, and to generate prefetch performance data for a plurality of combinations of block size and queue depth, based on the prefetch data;
a performance index calculator configured to generate index data for evaluating the prefetch performance data, based on the prefetch performance data; and
a parameter optimizer configured to generate an updated parameter by searching for a parameter that optimizes the index data and to transfer the updated parameter to the storage device,
wherein the performance index calculator is configured to generate the index data by taking into account an inversion interval in which prefetch performance decreases along with an increase in the block size or the queue depth.

17. The storage controller of claim 16, wherein the performance index calculator comprises:
a performance improvement calculator configured to generate performance improvement data for evaluating a degree of improvement in the prefetch performance, based on the prefetch performance data;
an inversion penalty calculator configured to generate inversion penalty data for evaluating a degree of reduction in the prefetch performance in the inversion interval, based on the prefetch performance data; and
an aggregator configured to generate the index data by a linear combination of the performance improvement data and the inversion penalty data.

18. The storage controller of claim 17, wherein the performance improvement calculator is configured to generate the performance improvement data by a linear combination of performance improvement ratio data, which indicates a degree of improvement in the prefetch performance due to application of the parameter as compared with the prefetch performance before the application of the parameter, and uniformity data, which indicates a degree of uniformity in the performance improvement ratio data along with an increase in the block size or the queue depth.

19. The storage controller of claim 17, wherein the inversion penalty calculator is configured to generate the inversion penalty data by a linear combination of first penalty data, which indicates a degree of reduction in the prefetch performance along with an increase in the block size, and second penalty data, which indicates a degree of reduction in the prefetch performance along with an increase in the queue depth.

20. The storage controller of claim 16, wherein the parameter optimizer is configured to generate the updated parameter based on Bayesian optimization.
